(19) United States
(12) Patent Application Publication
(10) Pub. No.: US 2025/0153725 A1
(43) Pub. Date: May 15, 2025

(54) METHOD FOR PREDICTING A TRANSVERSE DYNAMIC STABILIZATION BEHAVIOR OF A PRESENT VEHICLE CONFIGURATION OF A VEHICLE

(71) Applicant: ZF CV Systems Global GmbH, Bern (CH)

(72) Inventors: Oliver Wulf, Neustadt (DE); Klaus Plähn, Seelze (DE); Benjamin Bieber, Wedemark (DE); Jonas Böttcher, Hannover (DE)

(21) Appl. No.: 19/025,807

(22) Filed: Jan. 16, 2025

Related U.S. Application Data
(63) Continuation of application No. PCT/EP2023/064957, filed on Jun. 5, 2023.

(30) Foreign Application Priority Data
Jul. 18, 2022 (DE) 10 2022 117 856.0

(51) Int. Cl. B60W 50/06; B60W 50/00; B60W 50/14

(52) U.S. Cl. CPC B60W 50/06; B60W 50/0097; B60W 50/0098; B60W 50/14; B60W 2050/0031; B60W 2050/0083; B60W 2050/146; B60W 2300/145; B60W 2520/14; B60W 2530/10; B60W 2530/201; B60W 2530/205; B60W 2552/40; B60W 2556/10

(57) ABSTRACT

A method is for predicting a transverse dynamic stabilization behavior of a present vehicle configuration of a vehicle. The method includes ascertaining two or more geometric characteristics of the present vehicle configuration; ascertaining two or more load characteristics of the present vehicle configuration; generating an individualized vehicle model of the present vehicle configuration from a vehicle base model of the vehicle using the geometric characteristics and the load characteristics; predicting dynamic properties of the present vehicle configuration using the individualized vehicle model; and defining at least one drive dynamic threshold for the vehicle on the basis of the dynamic properties of the present vehicle configuration. A drive assistance system and/or a computer program is configured to perform the method. A vehicle includes the driving assistance system.

### CROSS-REFERENCE TO RELATED APPLICATIONS

This application is a continuation application of international patent application PCT/EP2023/064957, filed Jun. 5, 2023, designating the United States and claiming priority from German application 10 2022 117 856.0, filed Jul. 18, 2022, and the entire content of both applications is incorporated herein by reference.

### TECHNICAL FIELD

The disclosure relates to a method for predicting a transverse dynamic stabilization behavior of a present vehicle configuration of a vehicle. Furthermore, the disclosure relates to a driver assistance system for a vehicle, a vehicle, and a computer program product.

### BACKGROUND

An experienced professional driver can already judge on the basis of his experience whether a vehicle is behaving in a stability-critical manner. The driving style adopted by an experienced driver matches the given boundary conditions and enables the vehicle to be steered safely. The experience necessary for correctly judging the present situation generally only results after multiple years of practice, however.

In contrast, an inexperienced driver cannot or can only partially correctly assess the vehicle behavior that is to be expected. So-called virtual drivers, which control autonomous vehicles or perform partial tasks in the control of autonomous vehicles, also have not hitherto been able to ensure correct assessment of stability behavior. This involves the risk of a driving style unsuitable for the present vehicle configuration and as a result also an increased risk of accident. Known stability systems stabilize vehicles exclusively reactively, specifically when a significant deviation has built up between a setpoint behavior and an actual behavior of the vehicle. Conventional stability systems thus generally first intervene in the boundary range, so that significantly more space is required to regulate out the unstable state in comparison to a stable journey. There is therefore the need to predict transverse-dynamic instabilities of a vehicle reliably and avoid them if necessary by an adapted driving style.

DE 10 2007 008 486 A1 discloses a method for regulating the driving stability of a utility vehicle during a lane change maneuver in which pressures for individual brakes of the utility vehicle are ascertained as a function of multiple input conditions, so that the driving stability is increased by wheel-individual braking interventions, including the following steps: Predicting an unstable driving behavior during the change from a first curved path into a second curved path, applying a brake pressure to the curve-inner wheel in the event of predicted unstable driving behavior. In the disclosed method, the unstable driving behavior is ascertained in consideration of a first condition including the steps of ascertaining a coefficient of friction required for the stability of the utility vehicle, ascertaining an estimated utilized coefficient of friction, comparing the estimated coefficient of friction to the coefficient of friction required for the stability of the utility vehicle, and establishing that the first condition is met if the estimated coefficient of friction is below the coefficient of friction required for the stability of the utility vehicle. However, the prediction of the unstable driving behavior takes place in the method according to DE 10 2007 008 486 A1 only during a transition from the first curved path into the second curved path and therefore in reaction to an unsuitable driving style or a hazardous situation.

### SUMMARY

It is an object of the disclosure to reliably predict a transverse dynamic stability behavior of a present vehicle configuration and thus enabling an adapted vehicle guidance.

In a first aspect, the object is achieved by a method for predicting a transverse dynamic stability behavior of a present vehicle configuration of a vehicle, including the following steps: ascertaining two or more geometric characteristics of the present vehicle configuration; ascertaining two or more load characteristics of the present vehicle configuration; generating an individualized vehicle model of the present vehicle configuration from a vehicle based model of the vehicle using the geometric characteristics and the load characteristics; predicting dynamic properties of the present vehicle configuration using the individualized vehicle model; and defining at least one driving dynamics limiting value for the vehicle based on the dynamic properties of the present vehicle configuration.

The vehicle may particularly preferably be a utility vehicle. A utility vehicle, also a utility motor vehicle, is a motor vehicle which is intended in its design and configuration for the transport of people or goods, or for pulling trailers, but is not a passenger vehicle or motorcycle, but rather, for example, a bus, a truck, a tractor unit, or a crane truck. In the context of the present disclosure, the commercial vehicle can be a simple commercial vehicle, often also referred to in English as a “rigid vehicle”, or else a vehicle train made up of a towing vehicle and one or more trailer vehicles. A typical example of a vehicle train includes a semitrailer tractor and a semitrailer.

The method according to the disclosure enables instabilities to be prevented, which are already predictable upon more precise analysis of the present vehicle configuration and can therefore be passed on to the driver in the form of restrictions. The disclosure makes use of the finding that the transverse dynamic stabilization behavior of the vehicle is significantly influenced by the present vehicle configuration. Due to the consideration of the geometric characteristics and the load characteristics, the method according to the disclosure enables a reliable prediction of the dynamic properties of the vehicle in its present configuration. If the geometric characteristics and load characteristics of the current vehicle configuration are known, driving dynamics limiting values for the present vehicle configuration can be derived therefrom. Adhering to the driving dynamics limiting values ensures a safe and stable journey of the vehicle in standard operation. Interventions of conventional stability systems, often also referred to as electronic stability control (ESC) or electronic stability program (ESP®) are minimized since the vehicle no longer reaches the intervention thresholds of such systems in operation. However, it is to be understood that in exceptional situations, for example, in the case of damage to a tire of the vehicle, instabilities of the vehicle can occur in spite of adhering to the driving dynamics limiting values.

The present vehicle configuration relates to both vehicle-specific aspects and cargo-specific aspects. Furthermore, the present vehicle configuration can also include a coefficient of frictional connection between the vehicle and a roadway traveled by the vehicle. The geometric characteristics represent a geometry of the vehicle. Additionally or alternatively to geometric dimensions, the geometric characteristics can preferably also contain quantity specifications (for example, a number of axles of the vehicle). Geometric characteristics are in particular geometric variables that define the driving dynamics of the vehicle, such as a wheelbase of the vehicle, axle spacings between axles of the vehicle, a track width of the vehicle, a distance between a rear axle of the vehicle and a coupling point of a trailer, and/or a configuration type of a trailer vehicle (for example, drawbar trailer or center-axle trailer). In comparison to vehicles having a center-axle trailer or a semitrailer, vehicles having a drawbar trailer have an additional bending point, because of which vehicle configurations having a drawbar trailer are often more critical with respect to dynamic properties than vehicles having a center-axle trailer or semitrailer. A configuration type of the trailer vehicle can be taken into consideration via a geometric characteristic.

The present vehicle configuration also furthermore includes, in addition to the geometric characteristic of the vehicle, load characteristics. The load characteristics represent loads acting on the vehicle, which can result, for example, from the intrinsic weight of the vehicle and from a cargo of the vehicle. Thus, a current vehicle configuration of an unloaded vehicle is different from a current vehicle configuration of the same vehicle in the loaded state. A load characteristic can preferably be or include a wheel load, an axle load, a total vehicle mass, a mass of part of the vehicle and/or a location of a center of mass of the vehicle or of part of the vehicle. Furthermore, the load characteristics can preferably also include data which represent a wheel load, an axle load, a total vehicle mass, and/or a mass of part of the vehicle.

The prediction of the dynamic properties of the present vehicle configuration is carried out in a model-based manner and is therefore possible with foresight. Thus, a behavior of the vehicle is predictable. In one preferred embodiment, the vehicle model is a single-track model of the vehicle. The vehicle base model of the vehicle is preferably a parameterized model. This model can be individualized by setting the characteristics of the present vehicle configuration as values of the parameters. The vehicle base model can preferably also be individualized in that a towing vehicle model is supplemented by a trailer vehicle model corresponding to the present vehicle configuration. The vehicle base model can preferably be previously stored in the vehicle or remotely therefrom. Alternatively, however, the vehicle-based model can also be generated during the method, preferably by a control unit.

The dynamic properties can preferably include yaw behavior of the towing vehicle, articulation behavior of the trailer vehicle or of the trailer vehicles, natural angular frequencies of the vehicle, and/or damping levels of the vehicle or of the dynamic system formed by the vehicle.

A further finding underlying the disclosure is that in modern vehicles, a large number of geometric characteristics and load characteristics are already known, since they are processed in a variety of ways in different vehicle systems, such as an electronic braking system. The method can therefore be carried out particularly economically, in particular since separate sensors can often be omitted. The steps of the method are preferably carried out by a control unit. The control unit is preferably a brake control unit of a braking system of the vehicle. Many of the geometric characteristics and/or load characteristics are already provided and/or processed (for other purposes) had a brake control unit of a modern braking system, so that these characteristics can already be present at the brake control unit. Furthermore, a large amount of sensor data from sensors of the vehicle is often present at a brake control unit. Because the brake control unit is intended to carry out the method, a functionality corresponding to the method can be integrated particularly easily into a vehicle.

In a first embodiment of the method, generating an individualized vehicle model of the present vehicle configuration includes: approximating a mass distribution of the present vehicle configuration in at least one vehicle longitudinal direction using the geometric characteristics and the low characteristics; and generating an individualized vehicle model of the present vehicle configuration from a vehicle-based model of the vehicle using the geometric characteristics and the approximated mass distribution. A mass distribution of the vehicle can be concluded from the load characteristics and the geometric characteristics. This mass distribution in turn permits inferences about a center of mass location of the vehicle in the vehicle longitudinal direction or includes these inferences. A known center of mass location enables a particularly exact prediction of the dynamic properties. The quality of the approximation is dependent on the quality and/or the quantity of the available characteristics. With a high number and quality of the characteristics, the approximated mass distribution of the present vehicle configuration can come very close to the real existing mass distribution of the present vehicle configuration or can correspond thereto. If only limited information is available, the mass distribution can be determined approximately, for example, using lever principles. It is to be understood that a mass distribution of the present vehicle configuration can also be concluded using the load characteristics, for example, if axle load information is only available for one axle of the vehicle, for example.

The driving dynamics limiting value is preferably a maximum permissible vehicle speed, a maximum permissible lateral acceleration, a maximum permissible vehicle acceleration, a maximum permissible vehicle deceleration, a maximum permissible steering angle gradient, a maximum permissible steering frequency, or a minimum permissible curve radius of the vehicle. Multiple driving dynamics limiting values can also be defined for the vehicle via the method according to the disclosure, so that, for example, a maximum permissible vehicle speed is defined as a first driving dynamics limiting value and a maximum permissible lateral acceleration is defined as a second driving dynamics limiting value. The maximum permissible vehicle speed is not necessarily a speed at which instability of the vehicle immediately occurs when it is exceeded by the vehicle. On the contrary, instability may occur only when there is corresponding excitation, for example, when an avoidance maneuver is necessary. The maximum permissible vehicle speed can preferably be selected so that, at this vehicle speed, stable travel of the vehicle is still assured, even in the case of sudden avoidance maneuvers and/or cornering.

The geometric characteristics preferably include at least a number of the axles of the vehicle and an axle spacing between axles of the vehicle. The geometric characteristics particularly preferably include all the axle spacings between the axles of the vehicle. However, the method can also be carried out when only some or none of the axle spacings are known. When the vehicle length is known, for example, an axle spacing of the vehicle can preferably also be approximated. Wheels on the axles of the vehicle represent the point of contact of the vehicle with the roadway. The axle spacing influences the dynamic behavior of the vehicle and is particularly suitable as a geometric characteristic of the present vehicle configuration. If the ascertained geometric characteristics include at least a number of the axles of the vehicle and an axle spacing, the dynamic behavior of the vehicle can be predicted with high accuracy and comparatively low computing effort. Other or alternatively preferred geometric characteristics are, for example, a location of a coupling point to the rear axle of the towing vehicle, a location of a center point of an axle group of the trailer formed by multiple axles, a track width of the vehicle, and/or a wheelbase of the vehicle or of a sub-vehicle of the vehicle.

In an embodiment, the method further includes: Carrying out the ascertainment of the two or more geometric characteristics, the ascertainment of the two or more load characteristics, the generation of the individualized vehicle model, the prediction of dynamic properties of the present vehicle configuration, and the definition of the at least one driving dynamics limiting value during a vehicle activation of the vehicle, and renewed carrying out of at least the prediction of dynamic properties of the present vehicle configuration and the definition of the at least one driving dynamics limiting value if a change of at least one characteristic underlying the prediction of the dynamic properties is detected. The vehicle activation is putting the vehicle into a driving-ready state. The vehicle activation is often also referred to as commissioning, wherein this is not to include exclusively initial commissioning after a production of the vehicle. In conventional vehicles, the vehicle activation is generally carried out by actuating the ignition of the vehicle. Carrying out the above-mentioned steps during the vehicle activation ensures that the present vehicle configuration is reliably detected and used as the basis for the prediction. For example, it is also taken into consideration if the vehicle was loaded in the deactivated state. The renewed carrying out of the production of the dynamic properties and the definition of the at least one driving dynamics women value if a change of a characteristic underlying the prediction of the dynamic properties is detected and ensures that the driving dynamics limiting value is always adapted to the present vehicle configuration. If the vehicle is loaded, for example, in the activated state (with running motor), the dynamic behavior of the vehicle sometimes changes significantly. However, a load characteristic underlying the prediction also changes as a result of the loading, so that the prediction is carried out again and the driving dynamics limiting value is defined again or adapted to the changed conditions. In this way, the gain in safety provided by the method is further increased. The above-mentioned steps are carried out during the vehicle activation, wherein the steps do not have to be completed with the vehicle activation. The above-mentioned steps can preferably also be triggered by the vehicle activation.

One or more of the ascertained characteristics are preferably checked for plausibility after beginning a journey of the vehicle. Furthermore, the method is preferably carried out again if one the characteristics are implausible. In this case, the result of the plausibility check is preferably taken into consideration when carrying out the method again. The plausibility check increases the level of safety, since characteristics can be ascertained and excluded which are provided incorrectly by a vehicle system. Shortly after beginning a journey of the vehicle is, for example, a period of time of five minutes, preferably three minutes, particularly preferably one minute, after beginning a journey of the vehicle. The beginning of a journey is the moment when the vehicle departs a standstill or begins to move. Shortly after beginning the journey can preferably also be a period of time in which the vehicle is accelerated for the first time up to a predetermined speed after an initial standstill. The predetermined speed is preferably 30 km/h, more preferably 25 km/h, more preferably 20 km/h, more preferably 15 km/h, particularly preferably 10 km/h. Due to a limit which always exists of the drive power that can be provided by a drive of the vehicle, a minimum period of time passes until the vehicle reaches the predetermined speed from a standstill. This minimum period of time can preferably be used to check the plausibility of one or more characteristics, since the vehicle speed is low in this case and a risk of instabilities is negligible. A load characteristic which represents a total mass of the vehicle is preferably checked for plausibility while the vehicle is accelerated up to the predetermined speed. With a horizontal roadway, the total mass of the vehicle can thus be concluded from a known drive torque of a driver of the vehicle and from a period of time required to accelerate the vehicle to the predetermined speed, and this total mass can thus be checked for plausibility. Furthermore, an ascertained geometric characteristic which represents a coupled-on trailer vehicle of the vehicle can be checked for plausibility in that a total mass of the vehicle is concluded from a required drive power to reach a corresponding acceleration. Thus, for example, to accelerate a vehicle train which includes a towing vehicle and a trailer vehicle, a significantly greater drive power is required to reach an acceleration of 1 m/s2 than with an empty towing vehicle. The geometric characteristic which represents a coupled-on trailer vehicle is preferably ascertained by evaluating signals provided on a trailer network, particularly preferably a ISO11992 CAN.

In an embodiment, the method further includes: providing the driving dynamics limiting value at an interface. The interface preferably is or includes a human-machine interface, which particularly preferably includes a warning light, a head-up display, a digital display, and/or a loudspeaker. Providing the driving dynamics limiting value at a human-machine interface enables easy perception of the limiting value by a human driver so that they can take the driving dynamics limiting value into consideration when steering the vehicle. For example, a maximum permissible vehicle speed can be indicated on a speedometer of the vehicle.

Furthermore, the interface can preferably be configured as a network interface, particularly preferably a CAN interface. Via such a network interface, the limiting value can preferably be provided to a driver assistance system of the vehicle or a position regulator of the vehicle. The driving dynamics limiting value is preferably only provided at the interface when it is infringed. The maximum permissible vehicle speed can thus only be indicated by a head-up display, for example, when the vehicle moves at a speed greater than the maximum permissible vehicle speed. The method preferably furthermore includes: limiting a driving dynamics variable that can be provided by a vehicle actuator using the driving dynamics limiting value provided at the interface. The driving dynamics variable is preferably a vehicle speed of the vehicle. A control unit of the vehicle can preferably limit a vehicle speed of the vehicle based on a maximum permissible vehicle speed defined as a driving dynamics limiting value. The maximum permissible vehicle speed thus cannot be (inadvertently) exceeded by the driver, for example, since a maximum motor torque of a drive motor of the vehicle is limited by the control unit. When steering into a curve, the vehicle can preferably automatically be decelerated to a vehicle speed which corresponds to a maximum permissible lateral acceleration.

The method can preferably further include: taking into consideration the driving dynamics limiting value provided at the interface by way of a virtual driver in trajectory planning for the vehicle. The virtual driver is a unit which performs at least partial tasks of an autonomous control of the vehicle. The at least one partial task of the autonomous control of the vehicle includes trajectory planning. The virtual driver carries out trajectory planning and obtains a trajectory which is provided for the completion of a driving task, such as an autonomous trip from point to A to point B. The trajectory includes at least one planned driving path (setpoint driving path) that is to be travelled by the vehicle to complete the driving task. The trajectory furthermore includes at least one driving dynamics specification. This driving dynamics specification preferably is or includes a speed specified for traveling the driving path or a speed profile specified for traveling the driving path. The virtual driver plans the trajectory based on surroundings information, which is preferably provided by various surroundings sensors of the vehicle. The vehicle can thus have a camera, for example, which records the surroundings located in front of the vehicle in the direction of travel. The virtual driver then plans the trajectory to be traveled on the basis of the surroundings information provided by the camera. According to the preferred embodiment of the method, the virtual driver additionally also takes the driving dynamics limiting value into consideration in the trajectory planning. The speed provided for traveling the driving path can thus be restricted, for example, to 60 km/h (the driving dynamics limiting value is then a maximum permissible vehicle speed of 60 km/h), although a speed of 80 km/h is permissible by the traffic laws on the road to be traveled. The virtual driver can preferably carry out the trajectory planning using map data. The trajectory planning can also be carried out without surroundings information, in particular using map data. The virtual driver can thus preferably plan a slower but shorter highway route instead of a freeway route. This is preferred in particular if a maximum permissible vehicle speed is defined as a driving dynamics limiting value which is less than a permissible speed on a freeway associated with the freeway route. In this case, for example, a destination to be reached can be reached faster on the shorter highway route than on the longer freeway route, since no speed advantage can be achieved on a freeway route due to the specification of a maximum permissible vehicle speed.

In an embodiment, the method furthermore includes: ascertaining a present coefficient of frictional connection for the vehicle, wherein the present coefficient of frictional connection for the vehicle is taken into consideration in the prediction of the dynamic properties. Ascertaining the present coefficient of frictional connection for the vehicle is to be understood in the present case in terms of an approximation which can be subject to a certain approximation error. Due to the ascertainment of the present coefficient of frictional connection for the vehicle, the quality of the prediction of the dynamic properties of the present vehicle configuration is further improved, since the present coefficient of frictional connection is subject to large variations in reality. The coefficient of frictional connection prevailing between vehicle and roadway can thus be significantly reduced in relation to dry conditions in the event of wet or icy conditions. This results in a considerable effect on the dynamic properties of the vehicle. If the present coefficient of frictional connection is taken into consideration in the prediction of the dynamic properties, this possibly has an effect on the defined driving dynamics limiting value and the safety when operating the vehicle is increased. Without the step of ascertaining the present coefficient of frictional connection, the method can preferably be carried out based on a predefined or previously stored coefficient of frictional connection.

Historic control interventions of a stability control system for comparable vehicle configurations are preferably taken into consideration in the prediction of the dynamic properties of the present vehicle configuration. Such a stability control system is preferably an antilock braking system (ABS), a traction control system (TCS), and/or an ESC. A selected drive torque that is too high at wheels of the vehicle results in considerable tire slip (spinning of the wheels), especially when the roadway is wet or slippery. A traction control system prevents or minimizes this tire slip by an intervention matched thereto in the motor torque and braking of the spinning wheel. Drive slip as described above occurs in particular in unloaded or light vehicles due to lower wheel loads. If an intervention of the TCS has already taken place (a historic control intervention) for a comparable loading state (a comparable vehicle configuration), this can advantageously also be taken into consideration when predicting the dynamic properties of the present vehicle configuration. A maximum drive torque which can be applied to the roadway by the drive wheels of the vehicle for the present vehicle configuration can thus be oriented to the historic control intervention, for example. The method preferably includes: ascertaining an intervention of a stability control system and ascertaining exceeding of a driving dynamics variable triggering the intervention.

A comparable vehicle configuration is preferably a vehicle configuration having identical geometric characteristics and a maximum shift of the center of mass of the comparable vehicle configuration in relation to the center of mass location of the present vehicle configuration in a range of up to 1 m in one or more special directions, in particular up to 0.5 m, furthermore in particular up to 0.3 m. The comparable vehicle configuration can preferably also be characterized by an identical number of axles of the towing vehicle and/or the trailer vehicle. Furthermore, a vehicle configuration can preferably be comparable if the trailer vehicle is identical to the trailer vehicle of the present vehicle configuration or if the model type of the trailer vehicle is identical. The vehicle of the present vehicle configuration is preferably identical to the vehicle of the comparable vehicle configuration. The vehicle configuration can then preferably differ due to a loading of the vehicle and/or due to a lift status of a lift axle.

The method can preferably furthermore includes: monitoring an actual vehicle behavior of the vehicle in operation; comparing the actual vehicle behavior to a setpoint vehicle behavior, which is ascertained using the individualized vehicle model; and detecting an instability if the actual vehicle behavior deviates from the setpoint vehicle behavior. It is to be understood that preferably also only partial aspects of the actual vehicle behavior of the vehicle can be monitored and/or only partial aspects of the actual vehicle behavior can be compared to the setpoint vehicle behavior. Preferably, an instability can only be detected if the actual vehicle behavior deviates by a tolerance value from the setpoint vehicle behavior. And instability of the towing vehicle when driving through a curve can thus be detected, for example, in that a real yaw rate of the vehicle (rotation rate around the vertical axis) does not correspond to an expected yaw rate derivable from the steering angle or a provided trajectory (in case of a virtual driver). By comparing these yaw rates to one another, it is possible to distinguish between an oversteering or understeering situation in consideration of a required curve direction.

The actual vehicle behavior is preferably monitored by monitoring a bend angle between towing vehicle and trailer vehicle, which is ascertained from a bend angle signal of a bend angle sensor. Furthermore, the setpoint vehicle behavior is preferably a setpoint bend angle ascertainable using the vehicle model. Monitoring the bend angle permits monitoring of an overall train stability of the vehicle train. In this way, an instability of the trailer (jackknifing or breaking away) can be ascertained if a bend angle deviating from the setpoint bend angle results in a driving situation of the vehicle.

In an embodiment, the method furthermore includes: carrying out a safety operation if the vehicle exceeds one or more of the driving dynamics limiting values provided at the interface in operation. The safety operation is a method step which is carried out if an instability of the vehicle is imminent as a result of exceeding the driving dynamics limiting value.

The safety operation may preferably be setting a stability control system of the vehicle into a preventive regulation mode and/or applying an additional yaw torque when steering the vehicle. Understeering of the vehicle during cornering can preferably be compensated for by applying an additional yaw torque. By setting the stability control system in the preventive regulation mode, early intervention of the stability control system, preferably an ESC, is achieved so that possibly occurring instabilities of the vehicle are detected and compensated for early. In this case, a steering angle is less than would be the case without the preventive measure. Steering work or an integral of the steering angle required to drive through a curve is reduced. An intervention threshold of the stability control system of the vehicle is preferably reduced in the preventive regulation mode in relation to a regular regulation mode. Via the preferred embodiment, an already existing stability control system of the vehicle can thus be used to compensate for instabilities early.

The vehicle may preferably be a utility vehicle which is a vehicle train formed from a towing vehicle and at least one trailer vehicle, wherein the individualized vehicle model is an individualized overall vehicle model of the vehicle train. The individual overall vehicle model enables a particularly exact prediction of the dynamic properties of the present vehicle configuration, since the mutual influence between towing vehicle and trailer vehicle is taken into consideration in the prediction. The geometric characteristics of the present vehicle configuration preferably include geometric characteristics of the trailer vehicle. The load characteristics of the present vehicle configuration preferably include load characteristics of the trailer vehicle. The geometric characteristics and/or load characteristics the trailer vehicle are preferably ascertained based on signals which are provided at a trailer vehicle bus, preferably a CAN bus, particularly preferably a SAE J11992 CAN bus.

In an embodiment, the individualized overall vehicle model of the vehicle is a reduced individualized vehicle model if no geometric characteristics or load characteristics can be ascertained for a partial vehicle of the vehicle train. The partial vehicles are the towing vehicle and the trailer vehicles of the vehicle train. The reduced individualized vehicle model is preferably a vehicle model that only represents those components of the vehicle train for which the characteristics, axle loads, et cetera, have been ascertained. If only characteristics of the towing vehicle of the vehicle train can be ascertained, for example, the reduced individualized vehicle model is an individualized vehicle model of the towing vehicle without the trailer vehicle. The reduced individualized vehicle model is reduced in relation to the individualized overall vehicle model in that its representation of the present vehicle configuration is of lower quality than the individualized overall vehicle model. The reduced individualized vehicle model ensures that the prediction can be carried out even if the ascertainable characteristics are not sufficient to enable a realistic representation of the overall present vehicle configuration. Preferably, the partial vehicle for which no geometric characteristics or load characteristics can be ascertained can be represented in the reduced individualized vehicle model by a non-individualized base model. Preferably, a reference trailer model for a trailer vehicle can be taken into consideration in the reduced individualized vehicle model if geometric characteristics and load characteristics can only be ascertained for the towing vehicle of the vehicle train. A partial vehicle for which no geometric characteristics or load characteristics are ascertainable is preferably not taken into consideration in the prediction or is represented by a simplified base model in the prediction. It is to be understood that for a partial vehicle for which no load characteristics can be ascertained, but geometric characteristics can, at least the geometric characteristics can be taken into consideration in the reduced individualized vehicle model and vice versa.

The individualized overall vehicle model of the vehicle train is preferably a reduced individualized vehicle model if the load characteristics represent an unloaded state of the trailer vehicle. The inventors have recognized that unloaded trailer vehicles only result in instabilities of the vehicle in very rare cases. That is, for a vehicle train having an unloaded trailer vehicle, instabilities generally originate from the towing vehicle or another loaded trailer vehicle. In case of an unloaded trailer vehicle, a reliable prediction of the dynamic properties of the present vehicle configuration can also be achieved using a reduced individualized vehicle model that only takes into consideration the towing vehicle, for example. This permits a particularly resource-preserving performance of the method.

In a second aspect, the disclosure achieves the object stated at the outset by way of a driver assistance system for a vehicle, in particular a utility vehicle. The driver assistance system is preferably configured to carry out the method according to one of the above-mentioned preferred embodiments of the first aspect of the disclosure. The driver assistance system for a vehicle preferably includes a control unit which is configured to ascertain two or more geometric characteristics of a present vehicle configuration of the vehicle, ascertain two or more load characteristics of the present vehicle configuration, generate an individualized vehicle model of the present vehicle configuration from a vehicle-based model of the vehicle using the geometric characteristics and the low characteristics of the present vehicle configuration, predict dynamic properties of the present vehicle configuration using the individualized vehicle model, define at least one driving dynamics limiting value for the vehicle based on the dynamic properties of the present vehicle configuration, and provide the driving dynamics limiting value at an interface of the control unit.

According to a third aspect of the disclosure, the object mentioned at the outset is achieved by a vehicle having at least two axles, which includes a driver assistance system according to the second aspect of the disclosure. It is to be understood that the driver assistance system according to the second aspect of the disclosure and the vehicle according to the third aspect of the disclosure have identical and similar sub-aspects.

In a fourth aspect, the disclosure achieves the object stated at the outset by way of a computer program product having program code means stored on a computer-readable data carrier in order to carry out the method according to one of the above-mentioned preferred embodiments of the first aspect of the disclosure when the computer program product is executed on a computing unit. The computing unit is preferably a computing unit of a driver assistance system according to the second aspect of the disclosure.

### BRIEF DESCRIPTION OF DRAWINGS

The invention will now be described with reference to the drawings wherein:

FIG. 1 shows a present vehicle configuration of a utility vehicle according to a first embodiment;

FIG. 2 shows a present vehicle configuration of a utility vehicle according to a second embodiment;

FIG. 3 shows a schematic flow chart for a preferred embodiment of the method;

FIG. 4 shows an individualized vehicle model according to an embodiment;

FIG. 5 shows a diagram which illustrates a course of the lowest damping over the vehicle speed for various vehicle configurations;

FIG. 6 shows a schematic illustration of a utility vehicle during cornering;

FIG. 7 shows a schematic illustration of a utility vehicle during cornering at excess speed;

FIG. 8 shows a schematic flow chart of a preferred embodiment of generating an individualized vehicle model;

FIG. 9A shows a vehicle base model; and,

FIG. 9B shows a reduced individualized vehicle model.

### DETAILED DESCRIPTION

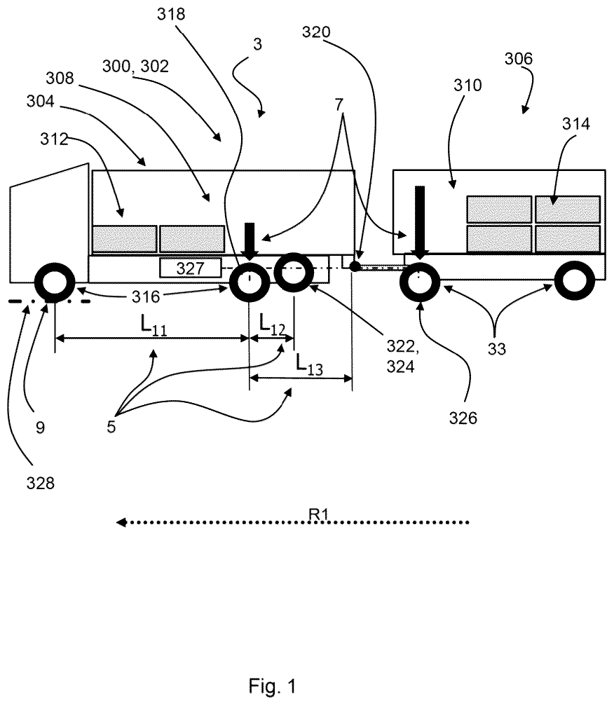

FIG. 1 illustrates a vehicle 300, which is a utility vehicle 300 configured as a vehicle train 302 here, which includes a towing vehicle 304 and a trailer vehicle 306. The towing vehicle 304 is a truck having a first cargo surface 308 and the trailer vehicle 306 is a drawbar trailer, which has a second cargo surface 310, connected to the towing vehicle 304. A first cargo 312 is arranged on the first cargo surface 308, while the second cargo surface 310 is loaded with a second cargo 314. FIG. 1 is to illustrate that a weight of the second cargo 314 on the second cargo surface 310 of the trailer vehicle 306 is approximately twice that of a weight of the first cargo 312 on the first cargo surface 308 of the towing vehicle 304.

The utility vehicle 300 shown in FIG. 1 is characterized by a present vehicle configuration 3. This present vehicle configuration 3 includes both geometric characteristics 5 and load characteristics 7. The characteristics 5, 7 of the present vehicle configuration 3 of the utility vehicle 300 are only illustrated on the basis of several geometric characteristics 5 and load characteristics 7 in FIG. 1 for better clarity. An axle spacing L₁₁ between two axles 316 of the towing vehicle 304, a coupling spacing L₁₃ between a rear axle 318 and a coupling point 320 of the towing vehicle 304, and a lift axle spacing L₁₂ between the rear axle 318 and a lift axle 322 of the towing vehicle 304 are shown as examples of geometric characteristics 5. The geometric characteristics 5 of the present vehicle configuration 3 furthermore include a lift status 324 of the lift axle 322. When the lift axle 322 is lowered, the driving dynamics effective wheelbase of the towing vehicle 300 for changes, specifically from the axle spacing L₁₁ shown in FIG. 1 to a sum of the axle spacing L₁₁ and half the lift axle spacing L₁₂. The dynamic behavior of the utility vehicle 3 is influenced by the wheelbase, wherein the lift status 324 of the lift axle 322 is a geometric characteristic 5 directly characterizing this influence. Further geometric characteristics 5 of the utility vehicle 300 shown are, for example, a drawbar length of a drawbar of the trailer vehicle 306 or a wheelbase of the trailer vehicle 306, which are not explicitly identified in FIG. 1, however.

The load characteristics 7 characterize the loads acting on the utility vehicle 300 in the present vehicle configuration 3, which result here from the intrinsic weight of the utility vehicle 300, from the first cargo 312, and from the second cargo 314. The load characteristics 7 are illustrated in simplified form in FIG. 1 as loads acting on the rear axle 318 of the towing vehicle 304 and a front axle 326 of the trailer vehicle 306. As has already been explained, the trailer vehicle 306 is loaded more heavily than the towing vehicle 304, so that the load acting on the rear axle 318 of the towing vehicle 304 is less than the load acting on the front axle 326 of the trailer vehicle 306. This is illustrated by the length of the arrows representing the load characteristics 7.

The load characteristic 7 acting on the rear axle 318 of the towing vehicle 304 is an axle load of the rear axle 318 here. This axle load is ascertained by an electronically controllable air suspension 327 of the utility vehicle 300. As a further load characteristic 7, the electronically controllable air suspension 327 ascertains the axle load acting on the front axle 326 of the trailer vehicle 306. In the present embodiment, in addition to the ascertained axle load on the rear axle 318 of the towing vehicle 304, a total mass of the towing vehicle 304 and the lift status 324 of the lift axle 322 are also known, so that an axle load on the front axle 330 of the towing vehicle 304 can be ascertained by computer. Furthermore, an axle load on a rear axle of the trailer vehicle 306 can be ascertained based on the axle load of the front axle 326 of the trailer vehicle 306 and a known total mass of the trailer vehicle 306. The load characteristics 7 can thus be directly metrologically recorded, on the one hand, and ascertained indirectly by calculation, on the other hand, in the present embodiment.

The vehicle configuration 3 can vary for the same utility vehicle 300 as a function of the geometric characteristics 5 and the load characteristics 7. A vehicle configuration the utility vehicle 300 would thus be different from the present vehicle configuration 3 shown in FIG. 1 if the lift axle 322 of the utility vehicle 300 were lowered (that is, the lift status would be different from the left status 324 shown in FIG. 1) or if the first cargo 312 and the second cargo 314 were exchanged. FIG. 1 is to illustrate that the present vehicle configuration 3 is situation-dependent and represents a current state of the utility vehicle 5.

A further factor that the present vehicle configuration 3 can include is a present coefficient of frictional connection 9 between the utility vehicle 300 and a roadway 328 indicated via a dashed line in FIG. 1. Even with identical geometric configuration of the utility vehicle 3 an identical cargo situation, the present vehicle configuration 3 of the utility vehicle 300 can vary due to different roadway conditions or due to a different coefficient of frictional connection 9. In particular on the basis of the coefficient of frictional connection 9, it is immediately comprehensible that the present vehicle configuration 3 of the utility vehicle 300 can also change during the operation of the utility vehicle 300. The coefficient of frictional connection 9 can thus decrease during a journey of the utility vehicle 300, for example, if it begins to rain.

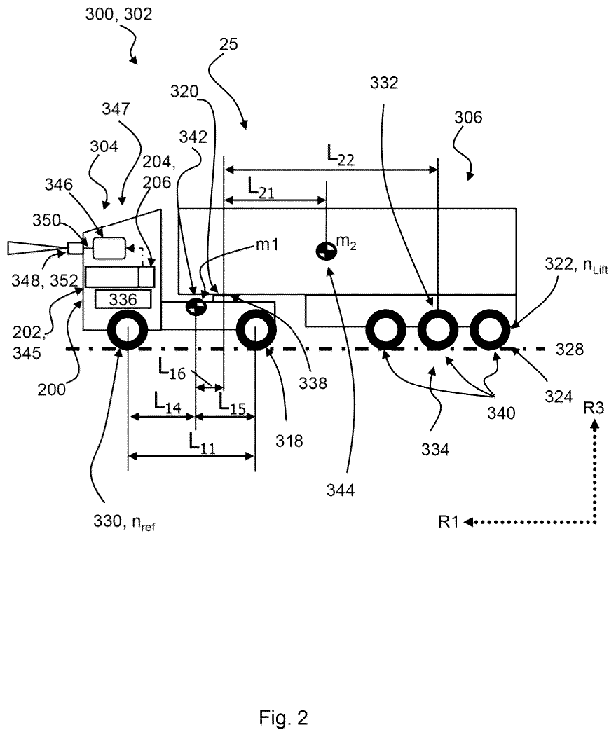

FIG. 2 shows a utility vehicle 300 configured as a vehicle train 302. The vehicle train 302 includes a towing vehicle 304 configured as a tractor unit and a trailer vehicle 306 configured as a semitrailer. Identical or similar components of the utility vehicles 300 according to FIG. 1 and FIG. 2 are identified by identical reference signs. A utility vehicle 300 as shown in FIG. 2 is typically in widespread use in Europe. The utility vehicle 304 has two axles 316, wherein the front axle 330 of the towing vehicle 304 is steered. This towing vehicle 304 pulls a three-axle semitrailer.

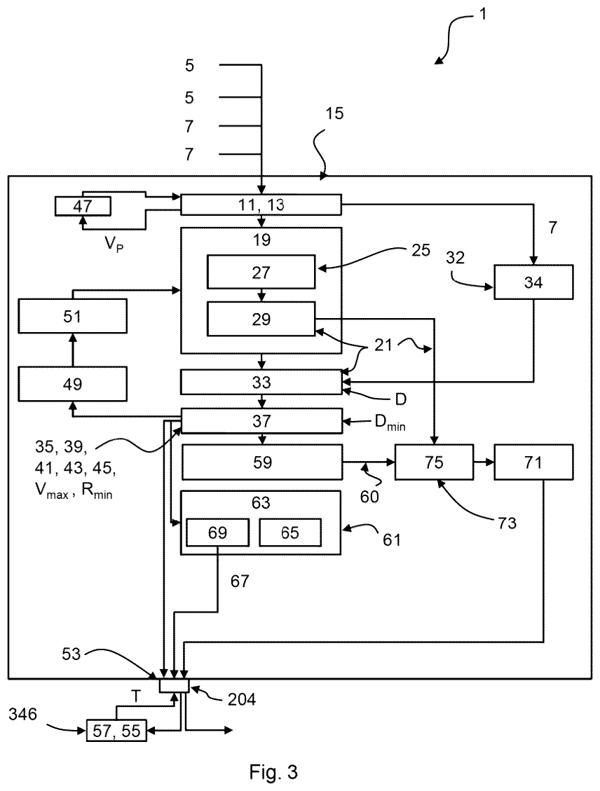

A preferred embodiment of the method 1 according to the disclosure is explained hereinafter essentially with reference to FIG. 2 and FIG. 3. Individual aspects which relate in particular to the motor vehicle 300 can possibly also be explained with reference to FIG. 1.

In a first step of the method 1 schematically shown in FIG. 3, two or more geometric characteristics 5 are ascertained 11. The first ascertained geometric characteristic 5 is the axle spacing L₁₁ between the axles 316 of the towing vehicle 304 here, which also corresponds here to the wheelbase of the towing vehicle 304. As a further geometric characteristic 5, a trailer coupling spacing L₂₂ is ascertained. The trailer coupling spacing L₂₂ is defined as the spacing between the coupling point 320 and an axle group center 332 of an axle group 334 of the trailer vehicle 306. Individual geometric characteristics 5 are also calculated on the basis of other previously ascertained geometric characteristics 5 for the vehicle 300 according to FIG. 2. In the present embodiment, a position of the coupling point 320 within the wheelbase of the towing vehicle 304 is ascertained based on a previously known total train length, which is prescribed according to EU guideline 96/53/EG, the length of a typical guideline-conforming trailer vehicle 306, and the wheelbase L₁₁ of the towing vehicle 304.

In parallel to ascertaining 11 the geometric characteristics 5, two or more load characteristics 7 are ascertained 13, which are not shown in FIG. 2 for reasons of clarity. In the present embodiment, the load characteristics 7 include axle loads acting on the front axle 330 and the rear axle 318 of the towing vehicle 304. Furthermore, the load characteristics for the utility vehicle 300 according to FIG. 2 include an axle load axing on the axle group center 332, which represents the axle loads acting on the individual axles 316 of the axle group 334.

Ascertaining 11, 13 the geometric characteristics 5 and the load characteristics 7 is carried out for the first time during a vehicle activation 15 of the utility vehicle 300. A vehicle type the utility vehicle 300 and geometric characteristics 5 (number of the axles 316, axle spacing L₁₁) are already known upon the activation of an ignition of the utility vehicle 300. Furthermore, other properties of the axles 316, such as the lift status 324 of the lift axle 322, are available. These are stored as geometric characteristics 5 in an ESC control unit 336 of the utility vehicle 300, since they are also required for conventional stability control systems 360. In the present case, the trailer vehicle 306 has an electronic braking system (EBS). The trailer vehicle 306 is connected via a trailer interface 328, which is configured here as an ISO11992 interface, to the towing vehicle 304. The trailer vehicle 306 provides signals for the towing vehicle 304 on the trailer interface 328, which are used to ascertain the geometric characteristics 5 of the trailer vehicle 306. The geometric characteristics 5 of the trailer vehicle 306 include a model type of the trailer vehicle 306, a number of the axles of the trailer vehicle 306, and their spacings to the coupling point 320. These geometric characteristics 5 of the trailer vehicle 306 are provided here directly at the ISO11992 interface, so that the ascertainment of the characteristics of the trailer vehicle 306 is a reception of the corresponding signals. In addition, the EBS trailer vehicle 306 has sensors (not shown in FIG. 3), which are assigned to the axles 316. These sensors ascertain axle loads present at the sensed axles 340 and provide corresponding signals at the trailer interface 328. The axle loads of the trailer vehicle 306 are in turn ascertained as the load characteristics 7 from these signals. Furthermore, ascertaining 13 the load characteristics 7 includes calculating an axle load on the front axle 330 of the towing vehicle 304 here.

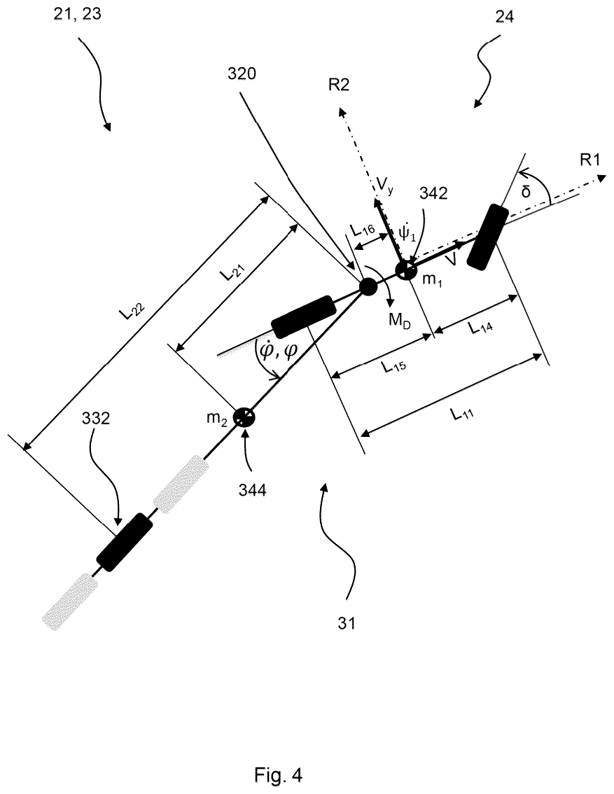

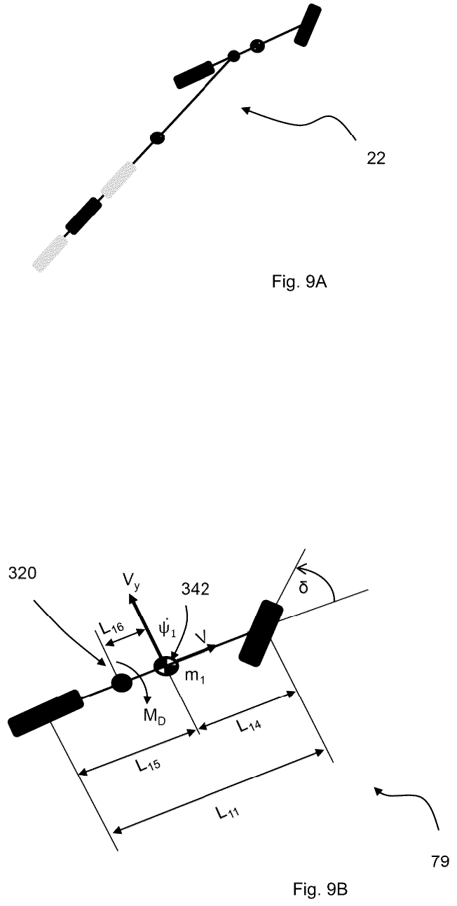

Following ascertaining 11 the geometric characteristics 5 and ascertaining 13 the load characteristics 7 (ascertaining 11 and 13 in FIG. 3), in a next step of the method 1, an individualized vehicle model 21 of the present vehicle configuration 3 is generated from a vehicle-based model 22 (cf. FIG. 9A) of the utility vehicle 300 (generating 19 in FIG. 3). FIG. 4 shows the individualized vehicle model 21, which is a single-track model 23 of the utility vehicle 300 here. The single-track model 23 is a simplified model of the utility vehicle 300, which maps the towing vehicle 304 and the trailer vehicle 306 from FIG. 2 in their minimal coordinates, wherein the vehicle width goes to zero and lifting, rolling, or pitching movements of the utility vehicle 300 are neglected. In the single-track model 23, the axle group 334 is replaced for simplification by a resulting axle at the axle group center 332. In FIG. 4, the individualized vehicle model 21 is an individualized overall vehicle model 24, which represents all partial vehicles of the utility vehicle 300 configured as the vehicle train 302. The individualized vehicle model 21 thus includes a (partial) model of the towing vehicle 304 and a (partial) model of the trailer vehicle 306.

The individualized vehicle model 21 is generated 19 using the geometric characteristics 5 and the load characteristics 7. For this purpose, in a first step a mass distribution 25 of the present vehicle configuration 3 in a vehicle longitudinal direction R1 is approximated (approximating 27 in FIG. 3). The location of a first center of mass 342 of the towing vehicle 304 in the vehicle longitudinal direction R1 is ascertained from the known axle loads on the front axle 330 and the rear axle 318 of the towing vehicle 304. The axle spacing L₁₁ is one of the previously ascertained geometric characteristics 5, so that with application of simple lever principles, the location of the first center of mass 342 in the vehicle longitudinal direction R1 can be concluded. In an analogous manner, when approximating 27 the mass distribution 25, the location of a second center of mass 344 of the trailer vehicle 306 in the vehicle longitudinal direction R1 is also ascertained. The mass distribution 25 includes a spacing L₁₄ between the front axle 330 of the towing vehicle 304 and the first center of mass 342, a spacing L₁₅ between the first center of mass 342 of the towing vehicle 304 and the rear axle 318 of the towing vehicle 304, a spacing L₁₆ between the coupling point 320 and the first center of mass 342, a spacing L₂₁ between the coupling point 320 and the second center of mass 344 of the trailer vehicle 306, a spacing L₂₃ between the coupling point 320 and the axle group center 332 of the axle group 334 of the trailer vehicle 306, a first mass m₁ of the towing vehicle 304, which engages in the first center of mass 342, and a second mass m₂ of the trailer vehicle 306, which engages in the second center of mass 344.

Generating 19 the individualized vehicle model 21 furthermore includes, following approximating 27 the mass distribution 25, generating 29 the individual vehicle model 21 of the utility vehicle 300 using the geometric characteristics 5 and the mass distribution 25. For this purpose, a parameterized vehicle base model 22 of the utility vehicle 300 is individualized by applying the geometric characteristics 5 and the load characteristics 7. The ascertained characteristics 5, 7 are thus used here as parameter values in the vehicle base model.

In addition to the characteristics 5, 7, the individualized vehicle model 21 includes movement degrees of freedom 31 of the utility vehicle 300 in the vehicle longitudinal direction R1 and a vehicle transverse direction R2, which is perpendicular to the vehicle longitudinal direction R1 and a vehicle vertical direction R3. These degrees of freedom in FIG. 4 are a first yaw rate 41 of the towing vehicle 304 around the first center of mass 342, a vehicle speed V in the longitudinal direction R1, a lateral speed V_{y} of the towing vehicle 304 in the vehicle transverse direction R2, a bend angle ¢ between towing vehicle 304 and trailer vehicle 306, and a bending speed \dot{φ}. The movement degrees of freedom 31 describe the possible movement directions of the force-coupled vehicle train 302 and can be specified as follows as a state vector x:

x=[V,V_{y},\dot{ψ}₁,ϕ,\dot{φ}]^{T}

A steering angle δ of the utility vehicle 300 and a frictional torque M_{D} in the coupling point 320 of the utility vehicle 300 are taken into consideration as input variables in the individualized vehicle model 21. An input variable vector u characterizing the input variables can be represented as follows:

u=[δ,M_{D}]^{T}

Specific values of the movement degrees of freedom 31 of the utility vehicle 300 result from the input variables or the input variable vector u and a system behavior of the individualized vehicle model 21 for the present vehicle configuration 3. For example, when the utility vehicle 300 is driving straight ahead, which is characterized by a steering angle δ of 0°, the yaw rate ψ₁ can also have a value of 0. The utility vehicle 300 then drives stably straight ahead and does not execute a rotational movement around its vertical axis.

Subsequently to the generation 19 of the individualized vehicle model 21, dynamic properties of the present vehicle configuration 3 are predicted using the individualized vehicle model 21 (predicting 33 in FIG. 3). For this purpose, movement equations for the utility vehicle 300, which represent the individualized vehicle model 21 here, are solved via suitable mathematical methods. In the present embodiment, the movement equations are linearized for an operating point which represents stationary straight ahead travel of the utility vehicle 300, due to which the state vector x of the utility vehicle 300 formed from the degrees of freedom simplifies as follows:

x=[V_{y},\dot{ψ}₁,ϕ,\dot{φ}]^{T}

During the stationary straight ahead travel of the utility vehicle 300, the occurring steering angles δ and bend angles ϕ are small, so that in this operating point the movement equations can be linearized and can be represented in matrix notation.

Tire restoring forces acting on tires of the axles 316 are linearly modeled in this embodiment and adapted via an empirical relationship to the respective axle load and a coefficient of frictional connection 32 between the roadway 328 and the utility vehicle 300. These tire skew rigidities are linearly modeled in this embodiment and adapted via an empirical relationship to the respective axial load and a coefficient of frictional connection 32 between the roadway 328 and the utility vehicle 300. In an analogous manner, the frictional torque M_{D} in the coupling point 320 is ascertained for the ascertained mass distribution 25, wherein a linear relationship between a load on the coupling point 320 and the frictional torque M_{D} is used. However, in other embodiments the frictional torque can also be taken into consideration as a nonlinear relationship.

The coefficient of frictional connection 32 can in principle be a specified value. However, in this preferred embodiment the method includes ascertaining 34 a present coefficient of frictional connection 32. For this purpose, initially weather conditions (not shown in FIG. 3) are ascertained. Subsequently, the present coefficient of frictional connection 32 is ascertained in that a coefficient of frictional connection 32 corresponding to the ascertained weather conditions and ascertained load characteristics 7 is selected from a previously stored database. However, the coefficient of frictional connection 32 can preferably also be measured or ascertained in another way.

A damping D and a natural angular frequency for the eigenvalues of the individualized vehicle model 21 of the utility vehicle 300 are subsequently each calculated when predicting 33 the dynamic properties for the operating point “stationary straight ahead travel” and for various vehicle speeds V (10, 20, 30, . . . , 120 km/h). It is thus ascertained which partial vehicle of the utility vehicle 300 has the least damping and from which vehicle speed V the damping falls below a predefined minimum measure of the damping D. Furthermore, the natural angular frequencies also themselves represent dynamic properties of the utility vehicle 300.

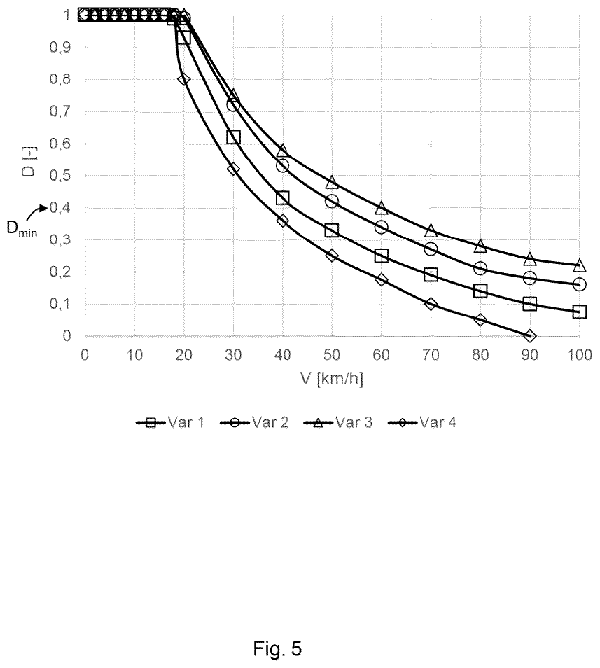

FIG. 5 illustrates for four present vehicle configurations 3 different from one another, which are identified by variant 1 to variant 4 (abbreviated in FIG. 5 as Var. 1 to Var. 4), the course of the least damping D of the utility vehicle 300 over the vehicle speed V. The damping levels D for all vehicle configurations 3 decrease with increasing vehicle speed V of the utility vehicle 300. A comparison of variant 3 and variant 4 additionally illustrates the influence of the present vehicle configuration 3 on the dynamic properties of the utility vehicle 300. Variant 4 represents a vehicle configuration 3 having a trailer vehicle 306 loaded at the rear, as shown in FIG. 1. The vehicle configuration 3 according to variant 4 has a low damping level D due to the rear-load loading state, so that steering excitations rapidly result in shaking of the utility vehicle 300. In contrast thereto, the vehicle configuration 3 according to variant 3, which represents a loaded towing vehicle 304 with empty trailer vehicle 306, has a significantly higher damping level D at equal vehicle speed V, so that excitations are damped and instabilities are prevented. An excitation which already induces an instability of the utility vehicle 300 in variant 4 can still be sufficiently damped with a utility vehicle according to variant 3 so that a stable journey is possible in spite of the excitation.

In the present embodiment, predicting 31 dynamic properties is completed with knowledge of the lowest damping level D and the natural angular frequencies of the utility vehicle 300 As a following step of method 1, a driving dynamics limiting value 35 for the utility vehicle 300 is defined 37 based on the dynamic properties of the present vehicle configuration 3. As a first driving dynamics limiting value 35, in this embodiment a maximum permissible steering frequency 39 is defined, which is less than the lowest natural angular frequency of the utility vehicle 300. A driving dynamics limiting value 35 thus defined prevents the utility vehicle 300 from entering resonance, which would have the result that the utility vehicle 300 already shakes in an uncontrolled manner as a result of a small deflection. Due to the described method 1 according to the disclosure, the critical natural angular frequencies are already known upon or shortly after the vehicle activation 15 and can be taken into consideration in the control of the utility vehicle 300 in the form of the driving dynamics limiting value 35.

A further driving dynamics limiting value 35 is ascertained from the ascertained lowest damping levels D of the utility vehicle configuration 5. An ideal damping for the utility vehicle configuration 5 corresponds to the damping level of D=1 for the ascertained eigenvalues. This damping level represents the aperiodic limiting case, in which an excited oscillation dissipates again without overshooting. In reality, this ideal damping level cannot be implemented or can only be implemented with disproportionately high positioning effort. In practice, however, a significantly lower damping level D is also sufficient for stable operation of the utility vehicle 300. As explained above with reference to FIG. 5, the damping level D decreases with increasing travel speed V of the utility vehicle 300. This means that the risk of instabilities of the utility vehicle 300 increases with increasing travel speed V. A travel speed V at which a required minimum damping measure Dₘᵢₙ is still just ensured is therefore calculated as a maximum permissible vehicle speed Vₘₐₓ which is not to be exceeded and is defined as a driving dynamics limiting value. In the present embodiment, the minimum damping level Dₘᵢₙ is configured at a value of Dₘᵢₙ=0.4. According to FIG. 5, a utility vehicle 300 according to variant 1 can only be safely moved up to a vehicle speed V of 40 km/h, whereas for a utility vehicle 300 according to variant 3, safe operation is still ensured up to a vehicle speed V of 60 km/h. Based on the lowest damping level D, furthermore a maximum permissible steering angle gradient 8 is defined as a further driving dynamics limiting value 35. The individualized vehicle model 21 preferably also includes a location of the centers of mass 342, 344 in the vehicle vertical direction R3. A maximum permissible lateral acceleration 41 and a minimum permissible curve radius Rₘᵢₙ can thus be defined as driving dynamics limiting values 35, the observance of which prevents the utility vehicle 300 from tipping over during cornering. Furthermore, a maximum permissible vehicle acceleration 43 and a maximum permissible vehicle deceleration 45 are defined as driving dynamics limiting values 35.

The above-described steps of the method 1 are carried out in this embodiment by a driver assistance system 200 of the utility vehicle 300. The driver assistance system 200 includes a control unit 202 and an interface 204. The control unit 202 is a brake control unit 345 of a braking system 347 of the utility vehicle 300 here, but can also be or include a control unit 202 of another vehicle subsystem, a main control unit of the utility vehicle 300, or a separately provided control unit 202.

Shortly after the beginning of a journey of the utility vehicle 300, the driver assistance system 200 checks several of the previously ascertained geometric characteristics 3 for plausibility (plausibility check 47 in FIG. 3). The driver assistant system 200 checks for plausibility in the present case the lift status 324 of the lift axle 322 of the utility vehicle 300, which is preferably provided on a SAE J1939 CAN bus of the utility vehicle 300. For this purpose, the control unit 202 of the driver assistance system 200 ascertains a reference rotational speed n_{ref} of a wheel of the front axle 330 of the towing vehicle and a wheel rotational speed n_{Lift} of a wheel of the lift axle 322 of the trailer vehicle 304 and compares them to one another. According to the vehicle configuration 3 shown in FIG. 2, the lift axle 322 of the trailer vehicle 304 is lowered. The wheel of the lift axle 322 and the wheel of the front axle 330 roll on the roadway 328, so that the wheel rotational speed n_{Lift} of the wheel of the lift axle 322 substantially corresponds to the reference rotational speed n_{ref}. The control unit 202 ascertains the corresponding rotational speeds n_{Lift}, href and ascertains that the lift status 324, which represents the lowered lift axle 322, is plausible.

The plausibility check 47 takes place shortly after the beginning of the journey of the utility vehicle 300, so that errors of the ascertained characteristics 5, 7 are detected early and in a stability-noncritical range of the vehicle speed V. In this embodiment, the plausibility check 47 takes place as soon the vehicle speed V has reached a plausibility check speed V_{P}, which preferably has a value of 5 km/h, for the first time after the vehicle activation 15. The plausibility check speed V_{P} is a minimum speed which triggers the plausibility check 47. The minimum speed ensures that sufficiently large differences occur between the ascertained characteristic and a real characteristic. In the present embodiment, reliable detection of implausible characteristics 5, 7 is then possible even if the reference rotational speed n_{ref} and the wheel rotational speed n_{Lift} of the lift axle 322 are only recorded with low accuracy.

One or more of the geometric characteristics 5 or the load characteristics 7 can change in operation of the utility vehicle 300. If, for example, in the utility vehicle 300 according to FIG. 1, the second cargo 314 of the trailer vehicle 306 is removed or the towing vehicle 304 is refueled, the load characteristics 7 and as a result also dynamic properties of the utility vehicle 300 change. To nonetheless ensure a stable journey of the utility vehicle 300, feedback is provided in the method 1. This feedback includes monitoring 49 the ascertained geometric characteristics 5 and the ascertained load characteristics 7 and detecting 51 a change of at least one characteristic 5, 7. As a result of a detection of a change of a characteristic 5, 7, the individualized vehicle model 21 is updated or generated again, the prediction 33 of dynamic properties of the present vehicle configuration 3 is repeated, and one or more of the driving dynamics limiting values 35 are redefined. The driving dynamics limiting values 35 defined in this case can differ both according to the nature of the limiting value type (speed variable, acceleration) and also the level of the limiting value from the vehicle dynamics limiting values 35 defined in the initial pass of the method 1. For example, the maximum permissible vehicle speed Vₘₐₓ can be increased if the trailer vehicle 300 is unloaded. Such unloading corresponds in the diagram according to FIG. 5 to a change of the vehicle configuration 3 from variant 4 to variant 3.

Following the definition 37 of the driving dynamics limiting values 35, the driving dynamics limiting values 35 are provided 53 at the interface 204 of the driver assistance system 200. The interface 204 is a network interface 206 here, which is connected to a virtual driver 346 of the utility vehicle 300. The driver assistance system 200 provides the previously defined driving dynamics limiting values 35 to the virtual driver 346 via the interface 204. The virtual driver 346 carries out trajectory planning 55 to obtain a trajectory T for the utility vehicle 300 and for this purpose accesses surroundings information 350 provided by a surroundings sensor 348 of the utility vehicle 300. In the embodiment according to FIG. 2, the surroundings sensor 348 is a camera 352 which records the surroundings located in front of the utility vehicle 300. The utility vehicle 300 can in other embodiments preferably also include multiple surroundings sensors 348, preferably radar sensors, lidar sensors, and/or cameras.

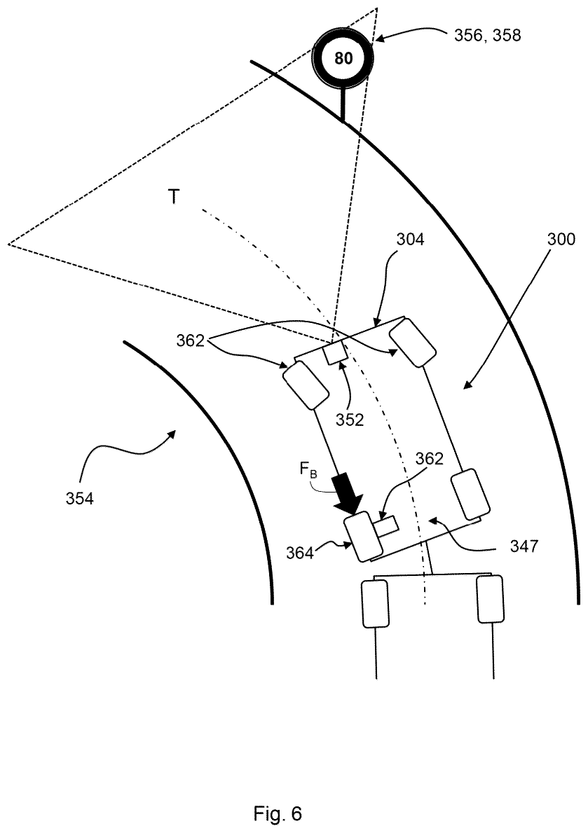

FIG. 6, which shows a top view of the utility vehicle 300 that is traveling through a curve 354, illustrates how the driving dynamics limiting value 35 can be taken into consideration in the trajectory planning 55. The virtual driver 346 plans the trajectory T for the utility vehicle 300 for traveling the curve 354. For this purpose, the camera 352 records a course of the roadway 328 located in front of the utility vehicle 300 as surroundings information 350. As further surroundings information 350, the camera 352 records a speed limit 358, which is specified on a road sign 356. In the illustrated route section, the permissible speed corresponds to a specified speed limit 358 of 60 km/h. Without specification of a driving dynamics limiting value 35, the virtual driver 346 would orient the vehicle speed V to the specified speed limit 358 and plan a vehicle speed V of 80 km/h for the trajectory T.

However, the utility vehicle 300 already behaves in an unstable manner at 80 km/h due to the rear-load loading in the present vehicle configuration 3. Without intervention of a stability control system 360, the utility vehicle 300 would become unstable upon traveling through the curve 354 at a vehicle speed V of 80 km/h. This instability can include, for example, oversteering or understeering of the towing vehicle 304 and/or jackknifing or breaking away of the trailer vehicle 306 as a result of a steering momentum. This threatening vehicle behavior is previously known due to the prediction of the dynamic properties of the utility vehicle 300, so that a maximum permissible vehicle speed Vₘₐₓ of 60 km/h was established when defining 37 the driving dynamics limiting value 35.

To prevent instability of the utility vehicle 300, the driver assistance system 300 provides this driving dynamics limiting value 35 to the virtual driver 346 at the interface 204. The virtual driver 346 takes into consideration the driving dynamics limiting value 35 provided at the interface 204 in the context of the trajectory planning 55 and limits a vehicle speed V of the utility vehicle 300 included by the trajectory T to the maximum permissible vehicle speed Vₘₐₓ. The utility vehicle 300 can thus travel through the curve 354 in a stable driving state and instabilities of the utility vehicle 300 do not occur. The consideration 57 of the driving dynamics limiting value 35 is illustrated in the schematic flow chart of the method 1 according to FIG. 3.

The preferred method 1 furthermore includes monitoring 59 an actual vehicle behavior 60 of the utility vehicle 300, which is carried out in this embodiment by the control unit 202 of the driver assistance system 200. The control unit 202 continuously monitors the vehicle speed V and then compares it to the maximum permissible vehicle speed Vₘₐₓ. If the utility vehicle 300 moves at a vehicle speed V which is greater than the maximum permissible vehicle speed Vₘₐₓ provided at the interface 204, a safety operation 61 is carried out (performance 63 in FIG. 3). The control unit 202 of the driver assistance system 200 sets the ESC controller 336 of the utility vehicle 300 into a preventive regulation mode (setting 65 in FIG. 3) here, so that a stability control system 360, which includes the ESC controller 336, can perform corrective control interventions on the utility vehicle 300 early in case of an instability of the utility vehicle 300.

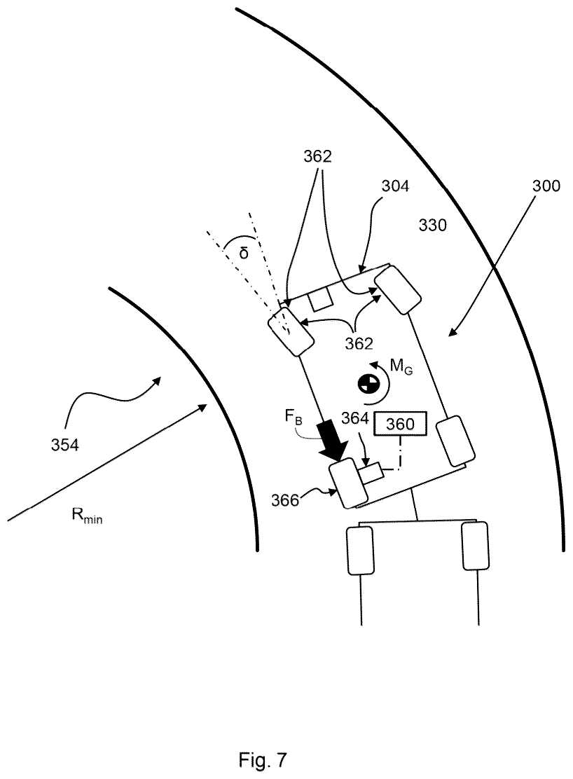

FIG. 7 shows the utility vehicle 300, which travels into the curve 354 at a vehicle speed V which is greater than the maximum permissible vehicle speed Vₘₐₓ. A steering angle δ is already specified at front wheels 362 of the utility vehicle 300 for steering in. Without driving dynamics intervention, the utility vehicle 300 would be carried outward out of the curve due to the excessive vehicle speed V. In addition to setting 65 the ESC control unit 336 into the preventive regulation mode, the control unit 202 of the driver assistance system 200, as an additional safety operation 61 during the steering and of the utility vehicle 300, provides a brake control variable 67 at the interface 204. Providing 69 the brake control variable 67 causes a braking force to be modulated at a curve-interior wheel 364 of the utility vehicle 300 by a brake actuator 362 of the braking system 347 connected indirectly or directly to the interface 204. This braking force causes an additional yaw torque M_{G} around the vertical axis of the utility vehicle 300. The yaw torque M_{G} causes a rotation of the utility vehicle 300 and thus has the result that the utility vehicle 300 can follow the curve 354. The safety operation 61 performed by the control unit 202 of the driver assistance system 200 thus prevents the understeering of the utility vehicle 300 and ensures a stable journey.

In addition to defining 37 the driving dynamics limiting value 35 and performing 63 the safety operation 61, the method in the embodiment shown furthermore includes detecting 71 an instability of the utility vehicle 300. As a first step of the detecting 71, following the monitoring 59 of the actual vehicle behavior 60 of the utility vehicle 300, the actual vehicle behavior 60 is compared 75 to a setpoint vehicle behavior 73. The setpoint vehicle behavior 73 is ascertained by the control unit 202 of the driver assistance system 200 using the individualized vehicle model 21 and using the trajectory T, which is provided by the virtual driver 346 at the interface 204 of the driver assistance system 200. If a deviation is ascertained upon comparing 75 the actual vehicle behavior 16 to the setpoint vehicle behavior 73, in a next step and instability of the utility vehicle 300 is detected 71. The detecting 71 can preferably take place chronologically before, in parallel to, or after the defining 37 of the driving dynamics limiting value 35. The monitoring 59 of the actual vehicle behavior 60 can also be carried out independently of the other steps of the method 1. Monitoring 59 of the actual vehicle behavior 60 is also already possible when no prediction 33 of the dynamic properties of the utility vehicle 300 has yet been performed or the prediction 300 is not yet completed. Preferably, a signal corresponding to a detected instability of the utility vehicle 300 is provided at the interface 204, so that it can be received by the virtual driver 346. The virtual driver 346 can thus take into consideration the detected instability of the utility vehicle 300 and preferably compensate for it.

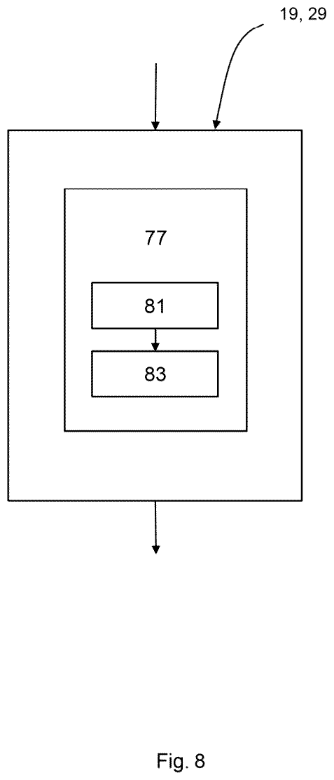

FIG. 8 illustrates a preferred embodiment of the generating 19, 29 of the individualized vehicle model 21, for the case that for the trailer vehicle 306 of the vehicle train 302, neither geometric characteristics 5 nor load characteristics 7 can be ascertained. In this second embodiment of the method 1, it is solely detected when ascertaining 11 geometric characteristics 5 that the utility vehicle 200 includes a trailer vehicle 306. To enable the predicting 33 of the dynamic properties of the present vehicle configuration 3 in spite of absent characteristics 5, 7 of the trailer vehicle 306, the generating 19, 29 of the individualized vehicle model 21 includes simplifying 77 the individualized overall vehicle model 24 to form a reduced individualized vehicle model 79. For this purpose, initially the vehicle model 22 of the vehicle train 302 shown in FIG. 9A is reduced (reducing 81 in FIG. 3). A model part representing the trailer vehicle 306 is removed from the vehicle base model 22. The vehicle base model 22 is then individualized 83 using the geometric characteristics 5 and the load characteristics 7 of the towing vehicle 304, in order to obtain the reduced vehicle model 79 shown in FIG. 9B, which now represents only the towing vehicle 304. The simplifying 77 can furthermore also take place if the load characteristics 7 ascertained for the trailer vehicle 306 identify an unloaded state of the trailer vehicle 306. In such a case, instabilities of the utility vehicle 300 originate in a very predominant number of the cases from the towing vehicle 304, so that a computing effort to be managed by the control unit 202 can be minimized by reducing the vehicle base model 22. The other steps of the method 1 following the generating 19, 29 can then be carried out as described above.

It is understood that the foregoing description is that of the preferred embodiments of the invention and that various changes and modifications may be made thereto without departing from the spirit and scope of the invention as defined in the appended claims.

### REFERENCE SIGNS (PART OF THE DESCRIPTION)

1 method
3 present vehicle configuration
5 geometric characteristics
7 load characteristics
9 current coefficient of frictional connection
11 ascertainment of geometric characteristics
13 ascertainment of load characteristics
15 vehicle activation
19 generation of an individualized vehicle model
21 individualized vehicle model
22 vehicle base model
23 single-track model
24 individualized overall vehicle model
25 mass distribution
27 approximation of the mass distribution
29 generation of the individualized vehicle model using the geometric characteristics and the mass distribution
31 movement degrees of freedom of the utility vehicle
32 coefficient of frictional connection
33 prediction of dynamic properties of the present vehicle configuration
34 ascertainment of a present coefficient of frictional connection
35 driving dynamics limiting value
37 definition of the driving dynamics limiting value
39 maximum permissible steering frequency
41 maximum permissible lateral acceleration
43 maximum permissible vehicle acceleration
45 maximum permissible vehicle deceleration
47 plausibility check of characteristics
49 monitoring of the ascertained characteristics
51 detection of a change of at least one characteristic
53 provision of the driving dynamics leavening values at an interface
55 trajectory planning
57 consideration of the driving dynamics limiting value in the trajectory planning
59 monitoring of an actual vehicle behavior
60 actual vehicle behavior
61 safety operation
63 performance of a safety operation
65 setting a stability control system into a regulation mode
67 brake control variable
69 provision of the brake control variable
71 detection of an instability
73 setpoint vehicle behavior
75 comparing the actual vehicle behavior to the setpoint vehicle behavior
77 simplifying the individualized overall vehicle model
79 reduced individualized vehicle model
200 driver assistance system
202 control unit
204 interface
206 network interface
300 vehicle; utility vehicle
302 vehicle train
304 towing vehicle
306 trailer vehicle
308 first cargo surface
310 second cargo surface
312 first cargo
314 second cargo
316 axles
318 rear axle of the towing vehicle
320 coupling point
322 lift axle
324 lift status
326 front axle of the trailer vehicle
327 electronically controllable air suspension
328 roadway
330 front axle of the towing vehicle
332 axle group center
334 axle group
336 ESC controller
338 trailer interface
340 sensed axles
342 first center of mass
344 second center of mass
345 brake control unit
346 virtual driver
347 braking system
348 surroundings sensor
350 surroundings information
352 camera
354 curve
356 road sign
358 speed limit
360 stability control system
362 front wheels
364 brake actuator
366 curve-inside wheel
D damping level
Dₘᵢₙ minimum damping level
F_{B} braking force
L₁₁ axle spacing
L₁₂ lift axle spacing
L₁₃ coupling spacing
L₁₄ spacing of front axle of towing vehicle and first center of mass
L₁₅ spacing of rear axle of towing vehicle and first center of mass
L₁₆ spacing of coupling point and first center of mass
L₂₁ spacing of coupling point and second center of mass
L₂₂ trailer coupling spacing
L₂₃ spacing of coupling point and axle group center
M_{D} frictional torque in coupling point
M_{G} yaw torque
m₁ mass of the towing vehicle
m₂ mass of the trailer vehicle
n_{Lift} wheel speed of a wheel of the lift axle
n_{ref} reference speed
Rₘᵢₙ minimum permissible curve radius
R1 vehicle longitudinal direction
R2 vehicle transverse direction
R3 vehicle vertical direction
T trajectory
V vehicle speed in vehicle longitudinal direction
Vₘₐₓ maximum permissible vehicle speed
V_{P} plausibility check speed
V_{y} vehicle speed in vehicle transverse direction
Var 1 to variants of vehicle configurations
Var 4
δ steering angle.
\dot{δ} maximum permissible steering angle gradient
ϕ bend angle
\dot{ø} bending speed
\dot{ψ}₁ first yaw rate

1. A method for predicting a transverse dynamic stabilization behavior of a present vehicle configuration of a vehicle, the method comprising:
ascertaining two or more geometric characteristics of the present vehicle configuration;
ascertaining two or more load characteristics of the present vehicle configuration;
generating an individualized vehicle model of the present vehicle configuration from a vehicle-based model of the vehicle using the geometric characteristics and the load characteristics;
predicting dynamic properties of the present vehicle configuration using the individualized vehicle model; and,
defining at least one driving dynamics limiting value for the vehicle based on the dynamic properties of the present vehicle configuration.

2. The method of claim 1, wherein said generating of the individualized vehicle model of the present vehicle configuration includes:
approximating a mass distribution of the present vehicle configuration in at least one vehicle longitudinal direction using the geometric characteristics and the load characteristics; and,
generating the individualized vehicle model of the present vehicle configuration from the vehicle base model of the vehicle using the geometric characteristics and the approximated mass distribution.

3. The method of claim 1, wherein the driving dynamics limiting value is a maximum permissible vehicle speed, a maximum permissible lateral acceleration, a maximum permissible vehicle acceleration, a maximum permissible vehicle deceleration, a maximum permissible steering angle gradient, a maximum permissible steering angle frequency, or a minimum permissible curve radius of the vehicle.

4. The method of claim 1, wherein the geometric characteristics include at least a number of the axles of the vehicle and an axle spacing between axles of the vehicle.

5. The method of claim 1 wherein:
said ascertaining the two or more geometric characteristics, said ascertaining the two or more load characteristics, said generating the individualized vehicle model, said predicting dynamic properties of the present vehicle configuration, and said defining the at least one driving dynamics limiting value are performed during a vehicle activation of the vehicle; and,
a renewed performance of at least said predicting dynamic properties of the present vehicle configuration and said defining the at least one driving dynamics limiting value is executed if a change of at least one characteristic underlying the prediction of the dynamic properties is detected.

6. The method of claim 1, wherein one or more of the ascertained characteristics are checked for plausibility after beginning a journey of the vehicle.

7. The method of claim 1 further comprising providing the driving dynamics limiting value at an interface.

8. The method of claim 7 further comprising taking into consideration the driving dynamics limiting value provided at the interface via a virtual driver during a trajectory planning for the vehicle.

9. The method of claim 1, further comprising ascertaining a present coefficient of frictional connection for the vehicle, wherein the present coefficient of frictional connection for the vehicle is taken into consideration when predicting the dynamic properties.

10. The method of claim 1, wherein historic control interventions of a stability control system for comparable vehicle configurations are taken into consideration when predicting the dynamic properties of the present vehicle configuration.

11. The method of claim 1 further comprising:
monitoring an actual vehicle behavior of the vehicle in operation;
comparing the actual vehicle behavior to a setpoint vehicle behavior, which is ascertained using the individualized vehicle model; and,
detecting an instability if the actual vehicle behavior deviates from the setpoint vehicle behavior.

12. The method of claim 7, further comprising performing a safety operation if the vehicle exceeds one or more driving dynamics limiting values provided at the interface in operation.

13. The method of claim 12, wherein the safety operation includes at least one of setting a stability control system of the vehicle into a preventive regulation mode and applying an additional yaw torque during steering of the vehicle.

14. The method of claim 1, wherein the vehicle is a vehicle train made up of a towing vehicle and at least one trailer vehicle; and, the individualized vehicle model is an individualized overall vehicle model of the vehicle train.

15. The method of claim 14, wherein the individualized overall vehicle model of the vehicle train is a reduced individualized vehicle model if no geometric characteristics or load characteristics can be ascertained for one of the towing vehicle and the at least one trailer vehicle of the vehicle train.

16. The method of claim 14, wherein the individualized overall vehicle model of the vehicle train is a reduced individualized vehicle model if the load characteristics represent an unloaded state of the trailer vehicle.

17. A driver assistance system for a vehicle, the driver assistance system comprising:
a processor;
a non-transitory computer readable medium having program code stored thereon;
said program code being configured, when executed by said processor, to:
ascertain two or more geometric characteristics of a present vehicle configuration;
ascertain two or more load characteristics of the present vehicle configuration;
generate an individualized vehicle model of the present vehicle configuration from a vehicle-based model of the vehicle using the geometric characteristics and the load characteristics;
predict dynamic properties of the present vehicle configuration using the individualized vehicle model; and,
define at least one driving dynamics limiting value for the vehicle based on the dynamic properties of the present vehicle configuration.

18. A vehicle comprising:
at least two axles;
a driver assistance system having a processor and a non-transitory computer readable medium having program code stored thereon;
said program code being configured, when executed by said processor, to:
ascertain two or more geometric characteristics of a present vehicle configuration;
ascertain two or more load characteristics of the present vehicle configuration;
generate an individualized vehicle model of the present vehicle configuration from a vehicle-based model of the vehicle using the geometric characteristics and the load characteristics;
predict dynamic properties of the present vehicle configuration using the individualized vehicle model; and,
define at least one driving dynamics limiting value for the vehicle based on the dynamic properties of the present vehicle configuration.

19. A computer program product comprising:
program code stored on a computer-readable medium;
said program code being configured, when executed by a processor, to perform the method of claim 1.
